(19) United States
(12) Patent Application Publication
(10) Pub. No.: US 2002/0184237 A1
(43) Pub. Date: Dec. 5, 2002

(54) Methods and apparatus for compiling, processing and disseminating equity transaction data

(76) Inventor: Brooks B. McFeely, Somerville, MA (US)

Correspondence Address: CHARLES G. CALL, 68 HORSE POND ROAD, WEST YARMOUTH, MA, 02673-2516, US

(21) Appl. No.: 10/116,007

(22) Filed: Apr. 3, 2002

Related U.S. Application Data
(60) Provisional application No. 60/281,074, filed on Apr. 3, 2001.

(51) Int. Cl. G06F 7/00

(52) U.S. Cl. 707/104.1

(57) ABSTRACT

A system for distributing data describing trading activity occurring on a plurality of different Electronic Communications Networks (ECNs), each of which receives buy and sell orders from stock traders and each of which performs equity sales transactions based on the received orders. Live data fed from each ECN describing pending buy and sell orders and executed transactions on each exchange are reformatted into standard form and aggregated to create, update and maintain consolidated trading data that is stored in a database. In response to one or more request specifications received from a remotely located user, the system extracts and processes selected portions of the consolidated data to produce response data returned to the requestor. This requested data may include streaming ticker tape and stock status data describing the status of all or a selected subset of stocks being actively traded on the multiple ECNs; an index value representative of the current selling price of a predetermined group of securities being traded on the multiple ECNs, depth-of-book data describing the current best pending offers to buy and sell one or more selected securities, and news stories concerning the securities being traded, including artificially generated natural language text news which is automatically produced by items of consolidated ECN data that satisfies predetermined conditions which define “newsworthy” events.

### FIELD OF THE INVENTION

This invention relates to data communication systems and more particularly to methods and apparatus for compiling, manipulating, and publishing up-to-date and real time financial news, information and data.

### BACKGROUND OF THE INVENTION

The Electronic Communication Networks (ECNs) are enjoying increasing use and have taken significant market share and volume from both the New York Stock Exchange (NYSE) and NASDAQ. ECN trades currently account for nearly 35% of the NASDAQ's total volume, and 3% of the NYSE's total volume. Although ECNs are active market participants during the regular trading day, they are the dominant market participants after-hours. Approximately 90% of financial and earnings releases are made after the regular markets close. There are an increasing number of trades made in the 4:00 to 10:00 pm (EST) and 6:00 to 9:30 am (EST) time periods (the extended hours market), and these trades are almost all made through brokers who use the ECNs which electronically match buy and sell orders and execute the trades.

Even though after-hours ECNs are experiencing exponential growth, individual and institutional investors often lack the useful data, news, real-time pricing and analytics needed to be fully informed participants in this market. There is accordingly a need for improved methods for gathering and distributing up-to-date news and data relating to financial transactions, corporate earnings reports and other news released by companies after the close of regular daily trading on the stock markets, as well as a need for the latest electronic trading data in the various ECN markets, including particularly the extended hours market.

There is a further need by online financial services to provide such data and financial news to their customers and others who use their services, and to do so in a cost-effective way that minimizes duplicative efforts to independently gather and organize such information. More specifically, there is a need for a single source of aggregated and real-time ECN equity trading news and data that can be used to assist the investment community in more effectively trading in the 24-hour global marketplace and which will permit online financial services to enable their customers and site visitors to make more informed investment decisions in the fast moving electronic marketplace.

### SUMMARY OF THE INVENTION

It is a leading object of the present invention to gather and disseminate data and information relating to equity ECNs

It is a further object of the invention to gather data concerning pending orders and executed transactions made by and through brokers using established ECNs.

The present invention takes the form of an automated system for gathering and consolidating data that are of value to traders, brokers and others who participate in or review ECN trading and the related data and information concerning such trading.

In accordance with a first aspect of the invention, data from a plurality of different ECNs are consolidated and made available to investors and others in a more useful and understandable form.

As contemplated by one feature of the invention, data describing pending orders from each ECN are aggregated to form consolidated ECN data that may be distributed in Extended Markup Language (XML) form to 3^{rd} parties. These consolidated order ECN data include depth of book data that may be displayed as a consolidated “limit order book” for each stock, showing current stock offers at the lowest prices and current bids for that stock at the highest prices for bids and offers made on multiple ECNs. The limit order book display mechanism accepts requests from users to display limit orders for a specific stock and further accepts requests from users to display limit orders from a specific ECN.

According to a further feature of the invention, the consolidated data describing executed transactions from a plurality of different ECNs is combined to form a consolidated ticker tape display that identifies each stock by symbol and shows the last trade price, percent change, and the number of shares traded for each stock. In addition, the ticker tape display data identifies the particular ECN that reported the trade, preferably shown as a subscripted symbol with each reported trade.

According to a further feature of the invention, the consolidated ECN data may be processed to form a stream of quote records, each of contains detailed information describing the market status of a given security, such as the ticker symbol identifying the security, the price of most recent trade and the number of shares exchanged during the most recent trade, the best bid price, the best ask price, and indication of the number of shares at best bid and ask prices, the day's trading volume in the security, the day's highest and lowest prices at which the security traded, and the time of the last trade in the security.

According to still another feature of the invention, the consolidated ECN data are used to calculate an index value based on the market cap of a predetermined set of stocks, such as the 1,000 top market cap stocks on the NASDAQ exchange. After the major exchanges close each day, the index value created from the combined ECN feed provides a valuable indication of overall market conditions and trends in the extended hours market.

As still another feature of the invention, the consolidated ECN data may be processed to identify newsworthy events, such as substantial gains or losses in a given stock or group of stocks, or unusually high trading volumes in a particular stock or group of stocks. When these events are detected, the data indicating the anomaly are automatically converted into a written text description of the event which is then routed to one or more designated recipients or information sources serving investors and/or brokers who are likely to have an interest in such an event.

These and other objects, features and advantages of the present invention may be more clearly understood by considering the following detailed description of a specific embodiment of the invention. In the course of this description, frequent reference will be made to the attached drawings.

### BRIEF OF THE DRAWINGS

FIG. 1 is a block diagram illustrating the relationship between the various entities that participate in an illustrative stock trading data aggregation and distribution system that implements the present invention;

FIG. 2 is a data flow diagram that illustrates the method for processing offer, bid and trade information obtained from a plurality of different ECNs in accordance with the invention;

FIG. 3 illustrates a web page display that enables subscribers to access consolidated data and financial news in a variety of useful ways;

FIG. 4 illustrates the layout of information as displayed in a consolidated streamer display window;

FIG. 5 shows the display layout of an alerts window;

FIG. 6 depicts the layout used in a conventional display of detailed data concerning a selected individual stock; and

FIG. 7 is a data flow diagram illustrating the manner in which standards-based Web services may be used to disseminate consolidated ECN data in response to service requests from remote users.

### DETAILED DESCRIPTION

Introduction

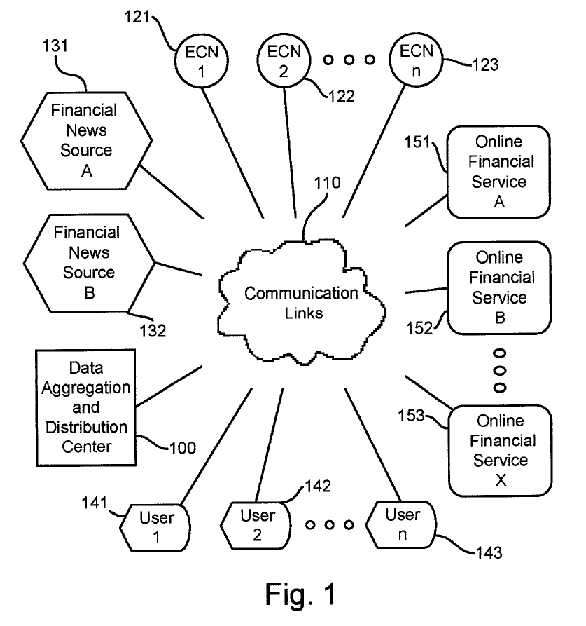

As is shown in FIG. 1, a data aggregation and distribution center 100 that implements the invention communicates with a number of remote computers via one or more communications facilities including the Internet, dialup and leased line telephone connections, and other communications links illustrated by the network “cloud” seen at 110.

The center 100 is coupled to and receives data from a plurality of Electronic Communication Networks (ECNs) illustrated at 121, 122 and 123. The center 100 also receives financial news from various sources as shown at 131 and 132. At the center 100, the ECN data and the financial news data are consolidated and made available in a variety of forms to be described below to individual investors, brokers and the like, as depicted at 141, 142 and 143, as well as to online financial services, information portals and other services shown at 151, 152 and 153 that redistribute the data provided by the center to end users.

Data Consolidation

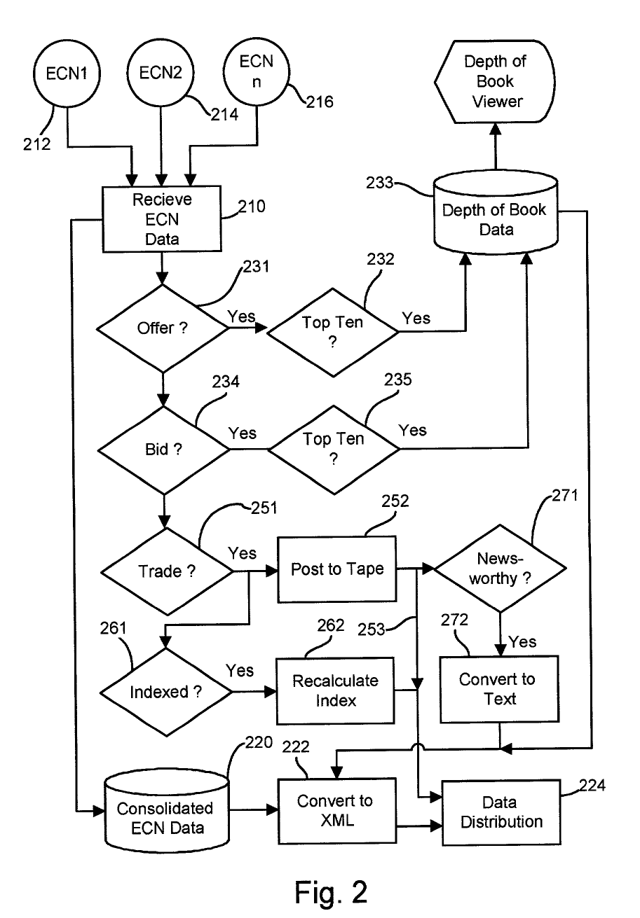

FIG. 2 of the drawings illustrates the manner in which the ECN data are consolidated and processed into more useful form for distribution to investors, brokers and others both directly and through financial services and online information portals.

As indicated at 210, data from a plurality of ECNs 212, 214 and 216 are received, processed and placed in a consolidated ECN data store seen at 220. As will be described, the ECN data are aggregated from the data feeds from multiple ECNs and then redistributed in modified form to end-users and to 3^{rd} party information distributors.

The data received at 210 and stored at 220 define:

a. the identity (ticker symbol) of a stock offered for sale, the offer price, and the number of shares;

b. the identity (ticker symbol) of a stock being bid for, including the bid price and the number of shares to be purchased;

c. the identity (ticker symbol) of a stock traded, the last trade price, and the number of shares traded; and

d. the identity of the particular ECN which is the source of the data.

This data are processed in a number of ways, as described below, placing the data in a form more useful to end users. The ECN data as consolidated are then converted into a predetermined format for use by others. Preferably, as indicated at 222 in FIG. 2, the compiled data are converted into Extended Markup Language (XML) as currently defined by the XML specification Extensible Markup Language (XML) 1.0 (Second Edition) W3C Recommendation, Oct. 3, 2000. The specific format for the consolidated data made available to others may take a variety of forms, each being specified by a Document Type Definition (as defined by the XML Specification) or a schema which conforms to the XML Schema Part 0: Primer; XML Schema Part 1: Structures; and XML Schema Part 2: Datatypes, W3C Proposed Recommendation, Mar. 16, 2001. By using XML schemas with typed data, efficient data transfers may be made between the aggregation and processing center and other systems.

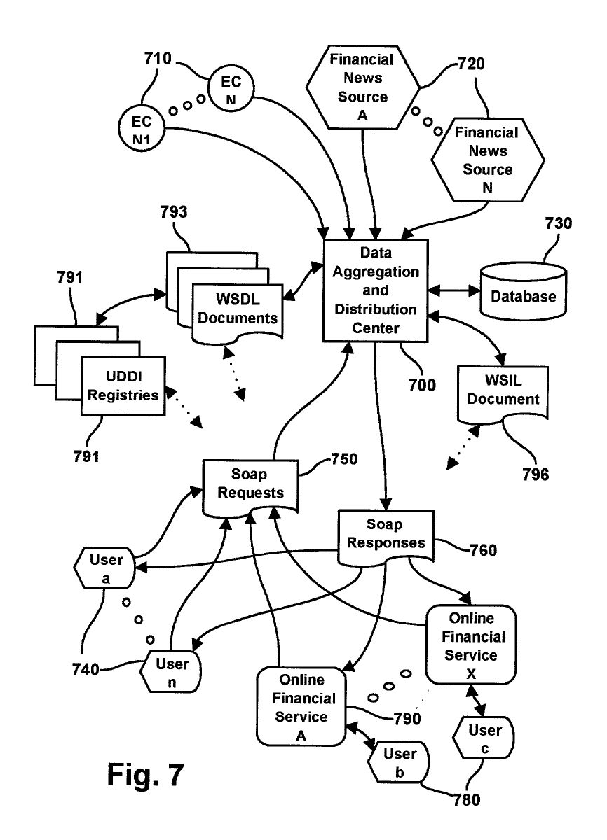

The resulting consolidated data may be distributed as indicated at 224 in a variety of known ways. For example, the data may be assembled into files and transferred using the Internet FTP protocol, the data may be placed in named files or dynamically assembled and returned to the user using standard Web server processing as described below in conjunction with FIGS. 2-6, or the data may be exchanged using a standard XML data exchange protocol such at the Simple Object Access Protocol (SOAP) 1.1, W3C Note, May. 8, 2000 or another XML protocol which employ XML to form information requests such as WebBroker, XML-RPC, BizTalk, ebXML, XMI, WebDAV, ICE and IOTP. As discussed in more detail later in conjunction with FIG. 7, the consolidated data may also be provided in a variety of forms by a one or more standards-based web services.

Disseminating Consolidated ECN Data Using the World Wide Web

The consolidated data may be delivered to traders via the World Wide Web using conventional HTML Web pages. Note that, by using standard XSLT style sheet translations, the XML provided by the data center from the consolidated ECN data may be readily translated into HTML form for display at either the server or client side. Such XSLT transformations may be used, for example, by online service providers as seen at 151-153 in FIG. 1 to transform XML data from the data aggregation and consolidation center 100 into HTML for incorporation into web pages delivered to their clients.

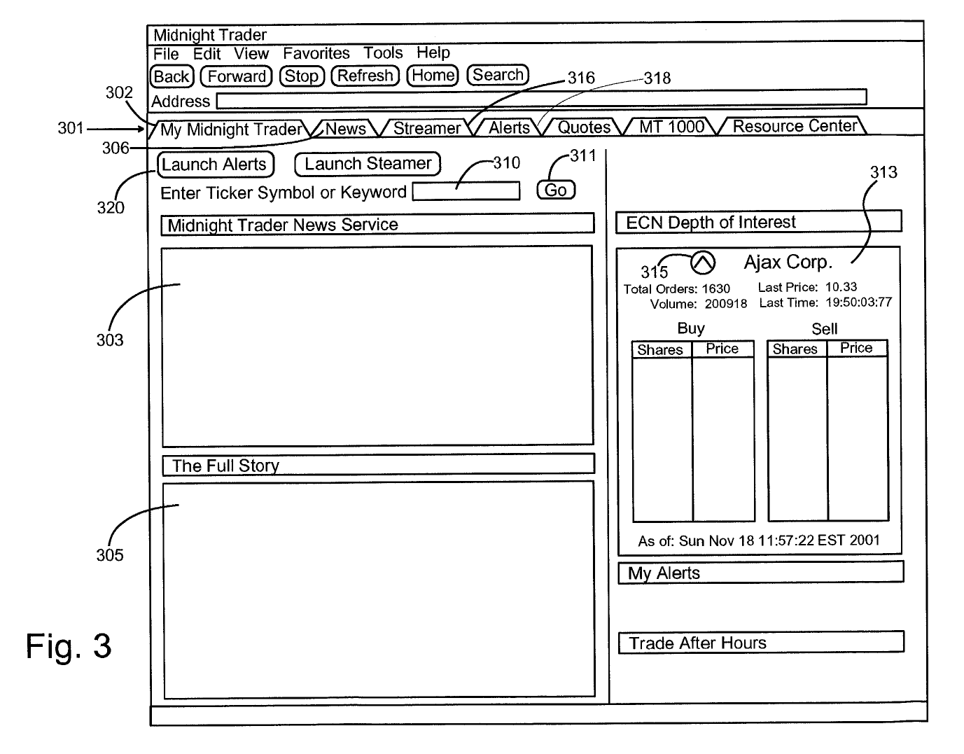

FIG. 3 of the drawings depicts a web page which enables subscribers to access consolidated data and financial news in a variety of useful ways. As displayed by conventional web browser program, such as Microsoft's Internet Explorer or Netscape's Navigator programs, the web page employs a tabbed notebook metaphor which allows the subscriber to display different kinds of information under tabs labeled “My Midnight Trader,”“News,”“Streamer,”“Alerts,”“Quotes,”“MT 1000” and “Resource Center.” These tabs are appear on the tab selection bar indicated generally at 301 in FIG. 3, and the nature of the information provided under each tab is described below.

News Service

The information displayed under the tab 302 labeled “My Midnight Trader” as shown in FIG. 3 includes a synopsis of recently received news under the heading “Midnight Trader News Service.” The news display occupies two scrollable subwindows at 303 and 305, with the upper window 303 displaying a list of brief summarizing headlines, with the most recently issued news headline appearing at the top of the list. The lower subwindow at 305 displays the text of the news story associated with a user-selected one of the headlines in subwindow 303. To see the details of any news story associated with a given headline displayed in the top window 303, the user simply clicks on that item to display the details of that story in the lower window 305.

By selecting the “News” tab 306, the subscriber may open a folder view web page which is specifically devoted to news display, permitting the headlines and accompanying full text details of news items to be displayed in larger subwindows.

Using either the “My Midnight Trader” tab or the “News” tab, the subscriber may enter a ticker symbol, such as “IBM,” in the input text box at 310 and then press the carriage return key or click on the adjacent “Go” button 311 to display information on the designated stock. At that time, the headlines of the most recently issued news items mentioning the designated stock are listed in subwindow 303, most recent first. The user may then select one of the listed headlines in subwindow 303 to see the detailed text of the selected news item in the scrolling subwindow 305.

The news financial that is as shown in FIG. 3 is obtained and aggregated from a plurality of news services as illustrated at 131 and 132 in FIG. 1, with each item being stored in a database for later distribution to subscribers and to financial services. To speed retrieval, an inverted file may be created at the data and aggregation center that indexes each item by the ticker symbols of companies mentioned in that news item. The displayed news items may include automatically generated text created from the consolidated ECN data as described next.

Automatic Generation of News Text from Data Manifesting Newsworthy Events

In accordance with the invention, the consolidated data from the ECNs and from other exchanges may also be processed by converting “newsworthy” events manifested by the data into readable text news items. This automated news generation feature may be incorporated into the consolidated ECN trade data reporting system is illustrated at 271 and 272 in FIG. 2.

Each time a trade occurs, it is processed against a rules-based algorithm that identifies newsworthy trading events. For example, any stock trade at a price which rises or falls by more than 10% from the previous day's closing would be regarded as “newsworthy” and would automatically generate a text description of the news event such as:

“Apr. 4, 2001-11:23 am EST Aardvark Industries (AAR) rose 12.5 to 89.7 in heavy trading, showing a gain of 23. 5% from its price on January 1^{st}.”

The rule based automated “news” generator may be implemented by a plurality of rules-based routines each comprising a condition part, an action part, and a destination part. The condition part performs tests on the data reflecting each trade to identify “newsworthy” conditions, such as previously unreported gains or losses in a given stock, unusually high volumes, or unusual behavior exhibited by selected groups of stocks in industry sectors (e.g. high tech, transportation, agriculture, etc.). The action part converts the data of interest that created the detected event into descriptive text form, and the destination part specifies one or more classes of recipients to which the resulting text news item should be distributed.

Users may be given the ability to specify criteria related to both market and equity specific trading activity in order to identify desired information. The interface will allow the end user to adjust several order, execution size and volatility filters in order to instantly display text descriptions of the requested market or issue specific activity. As described later, the subscriber may establish the conditions upon which he or she wishes to be alerted to the activity of specific stocks by establishing “alerts” and “alarms.”

The automatically generated news item text that is generated by this rules-based mechanism may be added to the conventional news items obtained from news services and displayed in the subwindows 303 and 305 and, in the same way, may be “filtered” in accordance with the stock symbol entered in the input text box 310.

Consolidated Depth of Book Data

Whenever a stock symbol or keyword is entered in the text box 310, consolidated depth of book information on the specified stock is also displayed in the subwindow 313. This window displays consolidated depth of book data as described in more detail next.

ECN data that reflects pending offers and bids on different ECNs may be advantageously consolidated to form “depth of book” data for each traded stock. To make trading possible, the ECNs provide current data on stocks that are offered for sale with the asking price and the amount being offered. Each ECN matches match those pending offers against bids for particular stocks at particular prices. At any given time, “depth of book” data describing the history of prior bids and offers can be assembled and displayed for a specified stock as described below.

As illustrated at 231 and 232 in FIG. 2, for example, the data from each ECNs can be processed to determine whether each incoming offer to sell is within the top ten open offers (i.e., the incoming offer is included if the identified stock is offered at a price lower than the tenth lowest current offer). If the offer meets that test, it is placed in the “depth of book” file for that stock in the depth of book database 233. Similarly, as illustrated at 234 and 235, if the incoming data from an ECN specify a bid for a stock that is within the ten highest bids for that stock, it is placed in the bid section of the depth of book file for that stock. Data on a new high bid or low offer are placed in the depth of book stack for that stock, replacing the data describing lowest bid or highest offer among those currently on the stack. When bids and offers are satisfied by a completed transaction, they are removed from the depth of book stack which is then refilled by the next bid or offer for that stock.

The resulting depth of book data may be distributed in XML form as illustrated at 237 or made available directly on request. By way of example, a user may request depth of book data on an identified stock that are then assembled in table form on an HTML page returned to the requester, showing the offers listed lowest-offer-first and the bids listed highest-bid-first. This top of book view would also display the last trade price and the number of shares traded, a “tick arrow” oriented to show whether the last trade was higher or lower than previous trade, the time of the last trade and the ECN which used to execute that trade, and the total volume, price and percent change since previous 4:00 pm EST market close. Those requesting depth of book information may choose both the stock to be displayed (by ticker symbol) and a selected ECN they would like to view.

The subwindow 313 on web page shown in FIG. 3 illustrates the manner in which depth of book data may be displayed to the user. The upwardly directed tick arrow seen at 315 indicates that the last trade of the selected stock was higher than the previous trade. In addition to the depth of book data for both bids (“Buy”) and offers (“Sell”), the subwindow 313 indicates the day's total trading volume and the time and price of the last trade.

Consolidated “Streamer” Display

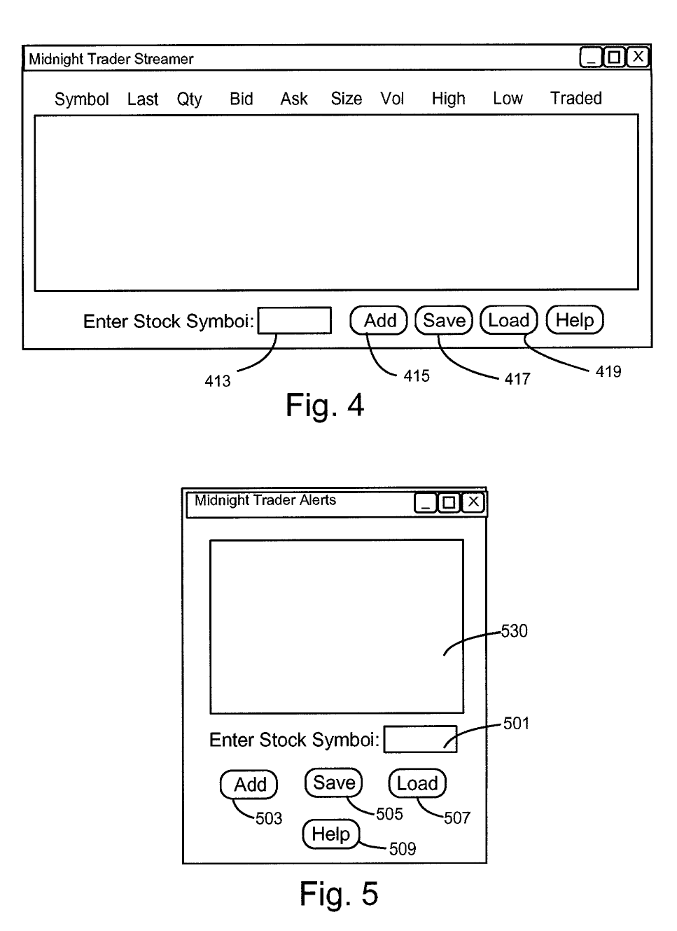

By selecting the “Streamer” Tab 316 on the tab selection bar 301, the subscriber may view instructions on the display and use of a consolidated streamer display which is launched and displayed in a separate window illustrated in FIG. 4.

The streamer window provides users with real-time, extended day stock quotes that reflect current regular session and extended-market trading activity on the major ECNs. The streamer displays the trade data for each stock symbol in real time in the columns of a single row displayed from left to right in the data subwindow 411 seen in FIG. 4: The data in each row is organized in ten labeled columns as follows:

| Column Label | Column Content |
|---|---|
| SYMBOL | Symbol or ticker for a given security |
| LAST | Price of most recent trade. |
| QTY | Number of shares exchanged during the most recent trade |
| BID | Best bid price |
| ASK | Best ask price |
| SIZE: | Number of shares at best bid and ask prices expressed as |
| | BidSize × AskSize (in 100's) |
| VOLUME | Today's trading volume (in 1,000's except for options) |
| HIGH | Today's highest trade price |
| LOW | Today's lowest trade price |
| TRADED | Time of Last trade (HH:MM:SS) |

The colors of displayed data in each row indicate the price of last trade, with red indicating the security is trading lower than the previous trade, green indicating it is has traded higher, and white indicating no change.

Controls displayed in the streamer window allow the user to establish one or more watchlists, each of which identifies a group of stocks which are of interest to the user. A stock may be added to the current display by placing its symbol in the input box 413 and pressing the Add button 415. Up to seven stocks may be displayed at one time in the streamer window. The contents of the current watchlist may be saved to a named file by pressing the Save button 417, and then reloaded later by pressing the load button 419 and supplying the previously specified name of the watchlist file. A user can establish several different watchlists to view stocks of potential interest as well as stocks already in the user's portfolio.

Alerts and Alarms

By selecting the “Alerts” tab 318 in the tab bar 301 seen in FIG. 3, the user can view instructions which describe the manner in which “alerts” may be established. Alerts visually and audibly notify the user when a specified stock has risen above or dropped below a designated bid, asked, or traded price. Alerts are particularly useful to users who wish to buy or sell at a specified price.

Alerts may be set by launching a separate alerts window illustrated in FIG. 5 by first pressing the “Launch Alerts” button seen at 320 in FIG. 3. The alerts window include an input text box 501, an Add button 503, a Save button 505, a Load button 507 and a Help button 509. The user employs the input text box 501 to specify the symbol of a stock of interest. When a symbol is entered in the input box 501 and the Add button 503 is pressed, a dialog box (not shown) opens that allows the user to specify a price, whether the price is a bid, asked or traded price, and whether the alert should be activated when the designated price is less than or greater than the transaction price. For example, the user might create a set of alerts for stock having the symbol “AJAX,” one of which would be activated if the last traded price rises above 107, another if the current best bid rises above 105, and a third if the best asked price falls below 110. Each named stock is separately listed in the list subwindow seen at 530 in the alert window, and a number in parenthesis after each listed stock symbol indicates the number of alerts set for that stock.

After the user has established a list of stocks each with zero or more alerts, the alert criteria may be saved into a named file and later reloaded using the save and load buttons 505 and 507 respectively. In addition, the user may also load a named watchlist file of stocks created for use with the streamer seen in FIG. 4 by using the Load button 507 on the alert window. The alerts for any given stock may be altered or deleted by right-clicking on an individual listed stock to add or edit existing alert settings.

Consolidated Extended-Hours Tape

In accordance with another feature of the present invention, the consolidated ECN data acquired may also be processed to produce a real-time “ticker tape” display of stock transaction data from multiple ECNs on one tape. As shown in FIG. 2 at 251, each trade reflected in the ECN data is translated into a format suitable for ticker tape display as indicated at 252 and then this ticker tape feed data is distributed in real time as indicated at 253. The tape data are preferably displayed in to two horizontal rows, with the top row describing executed trades of top 20 most actively traded issues by ECN while the bottom row is customized for each user, allowing individual users to specify specific stocks and indices to be listed. Each ECN stock transaction is preferably displayed on the output tape as illustrated by single ticker tape example below:

| MSFT 55.39 −0.19 | DAL 39.79 +0.54 | XQX_{ECN} 44.52 −1.43 |
|---|---|---|
| 434037 | 910200 | 784800 |

As seen above, each stock is identified by its ticker symbol, followed by the price traded and the change (as a numerical print) from the last trade. The number of shares traded is shown below each ticker symbol. For ECN stocks, the ECN handling the trade is identified by a three letter subscript designation as illustrated by the letters “ECN” following the ticker symbol XQX. When the price of the trade is up from the previous 4:00 pm EST close, the listing is shown using the color green, and if the price is down from the previous close, it is shown in red. The ticker may also show the last trade price and size (# shares). The actual display may be produced by either a special purpose viewer program which is resident on, and executes on, the user's computer, or a downloadable java applet that is downloaded from the Web site of the financial services company offering the consolidated ECN data feed provided by the data aggregation and distribution center 100 seen in FIG. 1.

Quotes

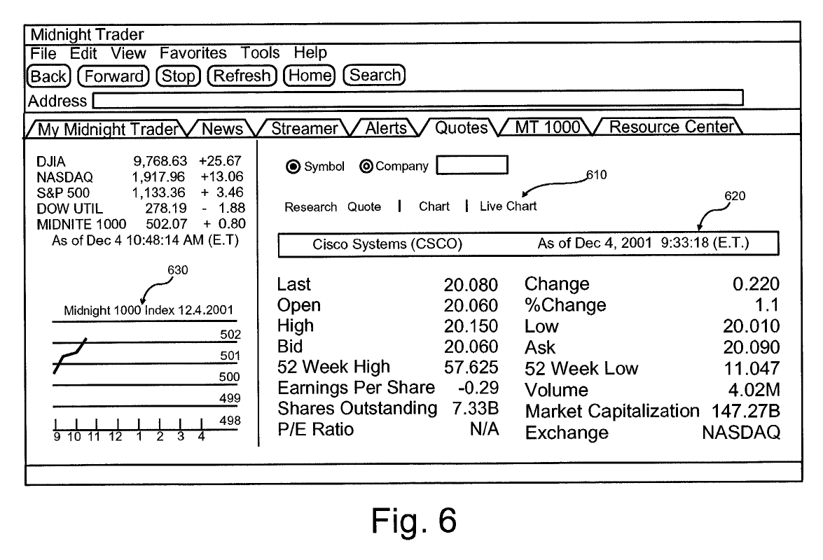

By selecting the “Quotes” tab on the tab bar, the user may view a conventional display of detailed data concerning a selected stock as illustrated in FIG. 6.

By clicking on “Research Quote,” “Chart” or “Live Chart” seen at 610, the user may vary the display at 620 to view data on the stock's performance as shown, or data graphically plotted vs. time on a chart display (not shown). Charted data, such as the daily performance of the “Midnight 1000” index as seen at 630 in FIG. 6, may be produced dynamically at the server by plotting relevant data in a bit-mapped image constructed by the processor, then converting that image into a standard file format (such as the .gif format displayable by web browser programs), saving that image file to an Internet accessible file location specified by a URL, and then imbedding that URL in an image tag in the web page transmitted to the user.

Extended-Hours Index Data

As another feature of the invention, the consolidated ECN data may be used to create an index that provides a valuable after-hour indication of current market conditions and trends. Using the consolidated ECN data feed, as indicated at 261, each trade of a stock in an indexed group of ECN traded stocks is identified and used to recalculate the index.

By way of example, an index may be formed from the current trading prices for 1,000 identified stocks. The consolidated ECN data may be scanned to determine the current selling price (last trade price) for each of these stocks and the after hours index value (e.g. reflecting the combined or average market capitalization of 1,000 individual indexed stock prices) may be calculated and distributed to interested users, just as the Dow Jones Industrial Average, the Standard and Poor's 500 Index, and the like are distributed. For example, this display could reflect the movement of the top 1,000 stocks by market cap on the NASDAQ throughout the 24 hour day. The index may be recalculated each time any one of the top 1,000 NASDAQ stocks trades at a price that is different from its previous trade price. The base value of the index will be 1,000, reflecting the state of the market when the index is first published. The principle advantage of this after hours index is this that it reflects trading activity and trends after the major markets are closed.

Consolidated Data Distributed Using Web Services

A Web Service, as that term is used here, refers to a software application or component identified by a Universal Record Identifier (URI) whose interfaces and interface bindings are capable of being described by standard XML vocabularies, and which support direct interactions with other software applications or components through the exchange of information that is expressed in terms of XML via Internet-based protocols. Web services typically (but not necessarily) employ messages for data exchange that comply with the Simple Object Access Protocol (SOAP). Each service is described by a retrievable XML service description which conforms to Web Services Description Language (WSDL) 1.1, defined by the W3C Note dated Mar. 15, 2001. Web services and the WSDL descriptions of those services may be discovered by potential users using the Universal Description, Discovery and Integration framework as currently defined in the UDDI 2.0 Specifications available at www.uddi.org., or by using the service identification XML documents published at provider's web sites which conform to the Web Services Inspection Language (WS-Inspection) 1.0 Specification (November 2001) available from both IBM and Microsoft. All of these Web services standards are currently undergoing further development, refinement and standardization under the auspices of Working Groups of the World Wide Web Consortium (W3C).

The consolidated data which is aggregated from multiple ECNs and other sources as contemplated by the present invention may be provided as one or more standards-based Web services in the manner illustrated in FIG. 7.

The central data aggregation and distribution center seen at 700 in FIG. 7 obtains data from several ECNs as indicated at 710, and from other sources such as the financial news services seen at 720. The received data is reformatted and mapped into a database schema for storage in the database 730.

Users may directly access specified data from the distribution center 700 by transmitting an XML SOAP request message and receiving the requested data in an XML SOAP response as illustrated at 740, 750 and 760.

Users may also indirectly receive consolidated data from the distribution center 700 by accessing 3rd party online providers, such as the online Financial Services seen at 770. For example, one of the online financial services might first fetch data from the distribution center 700 using a SOAP request 750 and receive the requested data in return as a SOAP response message 750. The received data may then be incorporated into an HTML page which is dynamically transmitted to the user 780 by the online financial service 770.

The distribution center 700 may advertise and describe available services by posting descriptions of its services in a UDDI registry 791, by publishing a description 793 of each available service in the Web Services Description Language (WSDL) in UDDI directories and at other locations, and by posting a listing 796 on the Web server offering these services, the listing 796 containing links to these WSDL descriptions expressed in accordance with the Web Services Inspection Language (WSIL).

The same kinds of consolidated data and news that is made available in Web page form as described above in connection with FIGS. 2-6 may also be obtained by invoking a selected Web service. The request inputs and response outputs for several kinds of illustrative Web services are listed in the table below:

| Request Parameters | Response |
|---|---|
| Stock Symbol, n | Consolidated data describing last n |
| | transactions for specified stock from |
| | all ECNs |
| Stock Symbol | Consolidated limit order book data for |
| | specified stock |
| Interval, First, Last | Midnight Trader Index values at each |
| | designated interval (Year, Month, |
| | Day, Hour, Minute) from First |
| | through Last) |
| Interval, First, Last | URL of retrievable gif file containing |
| | graph of Midnight Trader Index |
| | values at each designated interval |
| | (Year, Month, Day, Hour, Minute) |
| | from First though last |
| n | Up to n news most recent news stories |
| | excluding those previously sent to |
| | subscriber |
| Symbol, n | Up to n most recent news stories |
| | mentioning company designated by |
| | sticker symbol |
| Text string, n | Up to n most recent news stories |
| | containing input “Text string” |
| n | Most recent “Ticker tape” stock |
| | transaction data (up to n transactions) |
| | excluding data previously sent to |
| | subscriber |
| Symbol or n | Data describing current market status |
| | of the security specified by “Symbol” |
| | or the n most recently generated status |
| | records not previously sent to the |
| | requester. Each status record |
| | specifies the ticker symbol identifying |
| | the security, the price of most recent |
| | trade and the number of shares |
| | exchanged during the most recent |
| | trade, the best bid price, the best ask |
| | price, and indication of the number of |
| | shares at best bid and ask prices, the |
| | day's trading volume in the security, |
| | the day's highest and lowest prices at |
| | which the security traded, and the |
| | time of the last trade in the security. |
| n | Most recent rules-based automated |
| | text description of notable events |
| | exhibited by consolidated ECN data. |
| | Returns up to n most recent |
| | descriptions not previously sent to |
| | subscriber. |
| Symbol, price, (offered, bid | An alert message is pushed to the |
| for or sold), (below or above) | requester whenever the security |
| | designated by “Symbol” is offered, |
| | bid for, or sold at a price that is above |
| | or below the stated “price” as |
| | specified by the requester. |

Note that the services described above which deliver a single response may also be offered as “push” services; that is, the requester posts a request message which seeks information that is continually updated as needed by pushing new data to the requester that meets a designated request specification (such as all data on a specified stock). The service may enable the user to specify a time during which updates will occur, or may specify that updates be sent as they occur until cancelled at the request of the user.

Conclusion

It is to be understood that the specific embodiment of the invention that has been described is merely one illustrative application of the principles of the invention. Numerous modifications may be made to the arrangement described without departing from the true spirit and scope of the invention. What is claimed is:

What is claimed is:

1. A system for distributing data describing trading activity occurring on a plurality of different Electronic Communications Networks, each of which receives buy and sell orders from stock traders and each of which performs equity sales transactions based on said orders, said system comprising, in combination:
a first communications interface for receiving trading data describing pending buy and sell orders and executed transactions from each of said Electronic Communications Networks,
means for reformatting said trading data into a standard format,
means for combining said trading data in said standard format to form consolidated trading data,
a database for storing said consolidated trading data,
means for accepting a request specification,
means for extracting a portion of said consolidated trading data from said database in accordance with said request specification to create response data, and
a second communications interface for transmitting said response data to a remotely located system user.

2. The system as set forth in claim 1 wherein said trading data describing pending orders and executed transactions received from each of said Electronic Communications Networks comprises, in combination,
sell order data describing each offer to sell an offered stock and designating a stock symbol value identifying said offered stock, the per-share price at which said offered stock is offered for sale, and the number of shares of said offered stock that are being offered for sale,
buy order data describing each offer to buy a desired stock and designating a stock symbol value identifying said desired stock, the per-share price offered in exchange for said desired stock, and the number of shares of said desired stock which the buyer is willing to accept at said per-share price, and
executed transaction data describing each executed sales transaction for a purchased stock and designating a stock symbol value identifying said purchased stock, the per-share price at which said purchased stock was sold, and the number of shares of said purchased stock sold in said executed sales transaction.

3. The system as set forth in claim 1 wherein said request specification requests consolidated limit order data for a particular stock and wherein said means for extracting a portion of said consolidated trading data comprises means for retrieving data from said database describing selected pending buy and sell orders for said particular stock.

4. The system as set forth in claim 1 wherein said request specification further specifies that said response data be limited to data originating from a designated one of said Electronic Communications Networks.

5. The system as set forth in claim 2 wherein said request specification requests consolidated limit order data for a particular stock designated by a particular stock symbol and wherein said means for extracting a portion of said consolidated trading data comprises means for extracting selected sell order data describing a group of offers to sell said particular stock at the lowest prices and for extracting buy order data describing a group of offers to buy said particular stock at the highest prices.

6. The system as set forth in claim 5 wherein said request specification further specifies that said response data be limited to data originating from a designated one of said Electronic Communications Networks.

7. The system as set forth in claim 2 wherein said request specification specifies that said response data consist of consolidated streaming stock quotes for at least selected stocks, each of said stock quotes containing at least the symbol for a given security, the price of the most recent trade executed for that security, the number of shares traded in said most recent trade, the highest offered price in a pending buy order for said given security, and the lowest asked price in a pending sell order for said given security.

8. The system as set forth in claim 7 further including means for receiving a watch list specification from said remotely located system user which identifies said selected stocks.

9. The system as set forth in claim 2 wherein said request specification specifies that said response data consist of consolidated streaming stock quotes for at least selected stocks, each of said stock quotes describing the market status of a given security and specifying the ticker symbol identifying the security, the price of most recent trade and the number of shares exchanged during the most recent trade, the best bid price, the best ask price, and indication of the number of shares at best bid and ask prices, the day's trading volume in said given security, the day's highest and lowest prices at which said given security was traded, and the time of the last trade in the security.

10. The system as set forth in claim 9 further including means for receiving a watch list specification from said remotely located system user which identifies said selected stocks.

11. The system as set forth in claim 2 wherein said request specification is received from said remotely located system user is an alert request comprising the identification of a particular stock, the identification of a threshold price, and a request to notify said remotely located system user when a per-share price of said particular stock either exceeds or falls below said threshold price.

12. The system according to claim 2 wherein said request specification specifies that said response data consist of ticker tape data for at least selected stocks and wherein said response data comprises data records describing individual transactions on different ones of said Electronic Communications Networks, each of said records specifying the symbol identifying each given stock and further specifying the last trade price, percent change, the number of shares traded for said given stock, and the particular one of said Electronic Communications Networks where the described transaction occurred.

13. The system according to claim 2 including means for processing said executed transaction data describing each executed sales transaction occurring on said plurality of different Electronic Communications Networks to form an index value indicative of combined last per-share price at which each of a predetermined group of securities was traded and means for disseminating said index valueto remote users via said second communications interface.

14. The system as set forth in claim 1 further comprising means for processing said consolidated data to identify newsworthy events manifested by selected data items which satisfy predetermined conditions, means for translating said selected data items into natural language text data which describes said newsworthy events, and means for disseminating said natural language text data to remote users via said second communications interface.

15. The system as set forth in claim 14 further including means for receiving a watch list specification from an individual remote user that identifies one or more selected stocks and for thereafter disseminating only that natural language text which describes newsworthy events relating to said selected stocks to said individual remote user.

16. The system as set forth in claim 1 wherein said first communications interface additionally receives data containing financial news from one or more financial news services and wherein said second communications interface relays at least a selected portion of said financial news to said remotely located user.

17. The system as set forth in claim 14 further comprising means for processing said consolidated data to identify newsworthy events manifested by selected data items which satisfy predetermined conditions, means for translating said selected data items into natural language text data which describes said newsworthy events, and means for disseminating said natural language text data to remote users via said second communications interface to said remotely located user.
